(19) United States
(12) Patent Application Publication
(10) Pub. No.: US 2008/0017542 A1
(43) Pub. Date: Jan. 24, 2008

(54) Lockable Container and Method of Making

(76) Inventors: Thanhhung Le, Holy Springs, NC (US); Timothy Freeze, Mebane, NC (US)

Correspondence Address: MEADWESTVACO CORPORATION;ALEXANDRA B. URBAN,ESQ., 299 PARK AVENUE, 13TH FLOOR, NEW YORK, NY, 10171, US

(21) Appl. No.: 10/595,370

(22) PCT Filed: Oct. 18, 2004
(86) PCT No.: PCT/US04/34483

§ 371 Date: Jan. 31, 2007

Related U.S. Application Data
(60) Provisional application No. 60/511,336, filed on Oct. 16, 2003.

(51) Int. Cl. B65D 75/36; A23P 1/04; B65B 47/00

(52) U.S. Cl. 206/531; 425/383; 53/454

(57) ABSTRACT

Taught herein is a lockable container 10 for detachably connecting and securing a unit dose pack 20. A foldable portion 12 connected to the lockable container allows a unit dose pack 20 or a blister card 72 to be temporarily or permanently attached to a flap 16 or other structure within the container. Similarly, a blister card 70 connected to a lockable container 10 allows a blister pack 20 to be temporarily or permanently mounted to the blister card 70. Also, taught is a method of mounting a blister pack to a blister card.

### CROSS-REFERENCE TO RELATED APPLICATION

This application claims priority to co-pending U.S. Provisional Application No. 60/511,336, filed on Oct. 16, 2003. The entire disclosure of that prior filed application is hereby incorporated by reference.

### FIELD OF THE INVENTION

The invention relates to a lockable container and a method of securing a product within a lockable container. The lockable container is suitable for storing products such as medicaments held in a blister pack.

### BACKGROUND OF THE INVENTION

Containers with various lock apparatuses are well-known as there is a continual need to secure sensitive, delicate, or dangerous items. One type of item that may be considered dangerous is a medicament in the hands of an unintended user. For example, a unit dose prescription strength pharmaceutical accessible to a child is likely to be dangerous to that child. Accordingly, one purpose for developing lockable containers is to provide a child-resistant device that stores medicaments, such as unit dose packs.

The concept of unit dose packaging is attractive for certain pharmaceutical applications because it conveniently allows systematic dispensing of single doses, and also enables the user to track the consumption of doses according to the prescribed schedule. A feature of such packaging is that it is sturdy enough to be opened and closed numerous times until the course of medication is completed. Child resistance is a feature particularly desired for unit dose pharmaceutical packaging, and is mandated by the Poison Prevention Packaging Act of 1970. This general guideline is designed to ensure that the package maintains sufficient integrity against tampering by children.

Examples of such packages are described in commonly assigned U.S. Pat. No. 6,047,829 (Johnstone) and U.S. Published Application No. 2003/0062287 (Gelardi et al.). The Johnstone patent relates to a unit dose package that includes an outer sleeve and an inner slide card that is lockably retained within the sleeve. The Gelardi et al. application is related to a unit dose package formed from a flexible exterior cover surrounding a rigid frame, which includes an integral locking mechanism

Despite recent developments in child-resistant unit dose packaging, industry demands, marketplace changes, and consumer needs frequently require novel improvements to lockable containers. For example, a lockable container typically remains intact and usable much longer than the course of medicaments it stores. Thus a lockable container that is not reusable will be wastefully discarded well before the end of its useful life. In addition, a medicament may be issued in a package that is not child-resistant to a user that requires a child-resistant package. Further, a prescription refilled in a new lockable container rather than a used but entirely functional lockable container may be more expensive in order to cover the cost of the new container.

Accordingly, there remains in the art a need for lockable containers that address these unfilled needs. For example, a need exists for an inexpensive lockable container that can be provided with each new prescription; a need exists for an inexpensive lockable container that is reusable; a need exists for an inexpensive lockable container that can be filled with replacement packs or cards by the consumer; and a need exists for an inexpensive lockable container that can be filled with replacement packs or cards by a third-party healthcare provider, such as a pharmacist.

### SUMMARY OF THE INVENTION

Generally speaking, the present invention fulfills the needs identified above by providing various embodiments of a lockable container for detachably connecting and securing a unit dose pack, a multi-panel foldable blister card attached to a lockable container for mounting blister packs, a blister card that is attachable to a lockable container for mounting a blister pack, and a method of mounting blister packs to a blister card.

In exemplary embodiments, the lockable container of the present invention comprises a foldable portion comprised of a series of contiguous panels and a rigid molded plastic locking element. Unit doses may be contained within the container interior, preferably in or applied to a structure such as but not limited to a panel, card, dispenser, or appendage. As used herein, unit dose includes any discrete portion of an item that is separately contained by the container. Examples of a unit dose include alveoli or blisters on a support, syringes, pouches, pillows, wrapped portions, other containment vessels or any other form in which a material may be discretely dispensed or consumed. Within each discrete apportionment, the unit dose may also contain individual dispensable items, for example each alveoli or blister on a card may contain multiple tablets.

In exemplary embodiments, the foldable portion may be formed of a tear resistant flexible or foldable material including paperboard, plastic, laminate, hinged metals, or any combination thereof. The foldable portion preferably cooperates with the molded locking element to form a rigid frame enclosed by an outer covering. In this regard, one or more panels of the foldable portion typically are attached at least partially to the molded locking element to form the rigid frame, and additional panels are extended over the top and bottom of the frame to form the outer covering. The panels may be cut to fit within the frame provided by the molded portion, and may include one or more notches, cutouts, tabs, slots or the like to ensure precise fitting of the panels to the molded portion. In this regard, for example, the panels forming the top of the package may include slots to allow pass-through of the locking mechanism formed into the molded portion. The panel forming the bottom of the package may also include a restricted access such as one or more notches, cutouts, tabs, or flaps to allow access to and manipulation of the locking mechanism within the container.

The foldable portion may be formed from any paperboard suitable for packaging applications, including but not limited to bleached or unbleached, and uncoated or coated C1S or C2S. The paperboard may also be laminated with polymeric or other materials to provide additional rigidity and tear resistance, if desired. Alternatively the foldable portion may comprised of a plastic, such as used in thermo-forming applications. The foldable portion may be formed from a single piece, such as a unitary blank, and folded to form the respective panels of the container or, individual panels may be provided and attached to the locking element as needed to form the container. The same material may be used to provide the structure that receive or otherwise secure the unit doses.

In exemplary embodiments the molded locking element comprises a lock element and a lock release element. Some non-limiting embodiments of a suitable locking element and lock release element are described in detail in co-pending and commonly assigned U.S. Patent Application Pub. No. US 2003/0015438 A1, published on Jan. 23, 2003. The locking element forms a frame portion comprised of perpendicularly connected panels and a frame base that accommodates the elements of a slidable locking tongue. The frame base may be chemically or mechanically attached to at least one panel of the foldable portion.

The molded frame may be rectangular and include two end panels that are shorter in height and of lesser length than the two side panels. In addition to the end panels and the side panels, a slot housing panel may be interposed between the side panels and above the frame base. This panel includes a slot for receiving and engaging a tab dependent from a locking flap and is molded at a thickness sufficient to elevate it above the frame base and thus allow engagement of the locking tongue on its underside. The height of the slot housing panel also provides support to the locking flap when the container is closed.

A trigger mechanism may be used to deactivate the locking mechanism, which assumes a locked configuration in the molded, untensioned position. In various embodiments the trigger mechanism may be a circular pull ring, a T-shaped lever, or a rod. In one embodiment, when the ring is pulled the slidable tongue is moved to withdraw the curved dowel and the lateral tab from beneath the slot housing. Movement of the locking tongue in the pull direction may be limited by a pair of stops positioned in the frame base at a distance apart from the pull ring and by a stop ledge placed horizontally across the bar to engage the stops. The stop ledge is additionally configured to extend across and beyond the width of the bar, thus keeping the bar and pull ring positioned in the same plane as the frame base.

In one embodiment the locking flap is hingedly connected to one end panel of the molded package frame. Optionally the locking flap may include finger grips to permit easy access by the user. A dependent tab is attached to one end of the locking flap, preferably near its center region. The dependent tab includes a slot corresponding with the lateral tab attached to the locking tongue. The locking mechanism is secured when the dependent tab is engaged within the slot housing and the lateral tab engages the slot within the dependent tab.

The foldable portion is affixed to the molded plastic portion by any suitable means. Where the container is used to hold unit dose materials such as pharmaceuticals, medicaments, nutritional supplements, and the like, the unit dose containing element may be included within the interior of the container. Other consumable goods and a wide range of materials may also be packaged using this type of container, especially when dispensing of discrete amounts is required. Such elements may be selected from alveoli, blisters, pouches, pillows, foil inserts and other containment vessels, all formed by conventional means; and may be attached to the foldable portion that forms the container, or on a card inserted as a separate storage element within the container, or attached to an integral structure such as an appendage attached to either the frame or another panel. For example, where a blister card is incorporated into the package the blister card may be formed as one or more panels of the foldable portion, mounted to one or more of the panels, attached to one or more of the panels, attached to a separate panel within the frame, or attached to a structural element such as an appendage that is itself attached to the frame.

To close the package, the foldable portion is extended over the frame base and pressure applied in the region of the dependent tab of the locking flap to engage the tab with the slot in a slot housing panel. As the dependent tab is engaged within the slot, it slides past the protruding lateral tab to fit into place. In the fully locked position, the lateral tab exerts a positive force against the side of the dependent tab thus making it difficult to remove the dependent tab without applying a moderate amount of pressure to disengage the lateral tab. To open the container, the lateral tab is disengaged in order to withdraw the dependent tab from the slot housing panel. In this respect, the user's finger engages the pull ring at the bottom of the package, pulling the ring in the direction opposite the locking flap. The ring pulls the locking tongue and, in turn, the curved dowel outward from the slot housing panel. The positive contact between the lateral tab and the dependent tab is withdrawn, and thus the dependent tab may freely be removed from the slot housing panel. The locking flap may then be rotated about a living hinge to release the cover or top panel of the container.

As an additional security feature during opening, the locking flap may be partially trifurcated into three segments by a pair of slits near the innermost edge of the locking flap. Each segment so formed is capable of some limited movement in relation to the adjacent segment. To open the package, at least one segment is gripped and pulled outward from the package while the locking tongue is withdrawn from the slot housing panel to successfully open the locking flap.

Embodiments that provide features directed to the reusability and refillability of the above reference embodiments are also taught herein. For example, one alternative embodiment provides means for detachably connecting a conventional blister pack to a fold-over flap or panel. There, a foldable portion comprising: an edge attached to the frame, a cover panel, and a fold-over flap, is configured to receive a blister pack attached to the fold-over flap along their respective edges. When the contents of the blister pack are consumed, the blister pack may be detached from the fold-over panel and discarded, and a replacement blister pack may be attached to the fold-over flap or panel.

Another alternative embodiment provides for a blister card that also forms the foldable portion connected to the frame. There, a foldable portion comprising: a back panel, a spine, a cover panel, and at least one interior panel configured as a blister card to receive a mounted blister pack, is attached to the frame. For purposes of this disclosure, a mounted blister pack includes all combinations of face-mounted and/or back-mounted blister packs temporary or permanently affixed or otherwise mated to a blister card. A peel-drop blister pack may be more suitable for face mounting while a push-through blister pack may be more suitable for back mounting, but this exemplary pairing is merely illustrative and not a limitation regarding mounting configurations. Multiple mounted blister packs may then be folded and nested within the interior of the lockable container.

Yet another alternative embodiment provides a blister card configured to receive a mounted blister pack, which may then be attached to the frame or foldable portion before being secured within the lockable container. For example, a blister pack may be face or back mounted to a blank panel having at least one aperture. That panel may then be directly connected to the frame, a structure within the frame, or the foldable portion in such a way that when the container is locked, the blister pack is secured and accessible only by successfully manipulating the locking element. Alternatively, the mounted blister card may be used in combination with another container, or simply by itself.

### BRIEF DESCRIPTION OF THE DRAWINGS

FIG. 1 is an isometric view of an embodiment of a partially opened lockable container according to the present invention.

FIG. 2 is a plan view of an embodiment of the foldable portion according to the present invention.

FIG. 2A is a plan view of an alternative embodiment of the foldable portion according to the present invention.

FIG. 2B is a side view of the embodiment of FIG. 2A with blister packs mounted there.

FIG. 3 is an isometric view of an embodiment of a lockable container according to the present invention.

FIG. 4 is a plan view of an embodiment of a lockable container according to the present invention.

FIG. 5 is an isometric view of an embodiment of a lockable container according to the present invention.

FIG. 6 is a transverse section through an embodiment of a lockable container according to the present invention.

### DETAILED DESCRIPTION OF THE INVENTION

As required, detailed embodiments of the present invention are disclosed herein. It will be understood that the disclosed embodiments are merely exemplary of the invention that may be embodied in various and alternative forms. The figures are not necessarily to scale, and some features may be exaggerated or minimized to show details of particular components. In other instances, well-known materials or methods have not been described in detail in order to avoid obscuring the present invention. Therefore, specific structural and functional details disclosed herein are not to be interpreted as limiting, but as a basis for the claims and for teaching one skilled in the art to variously employ the present invention.

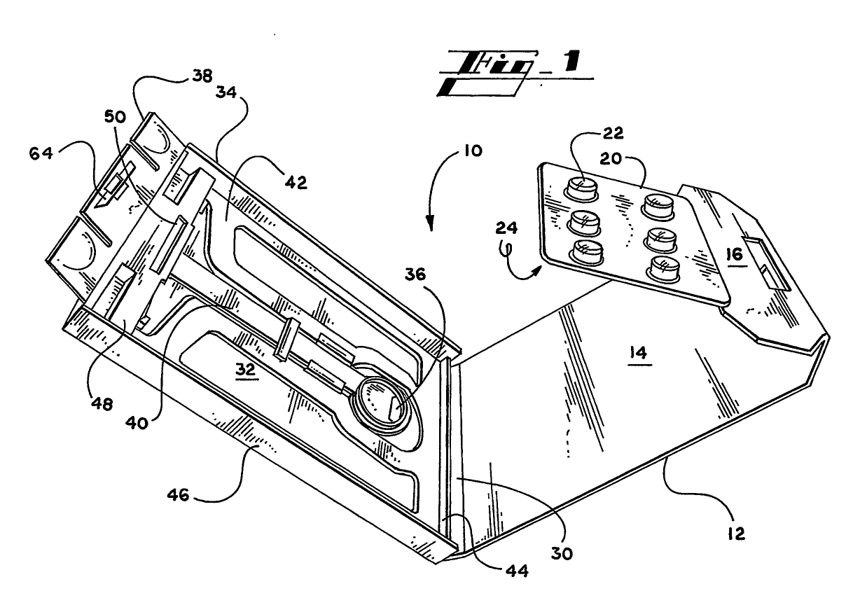

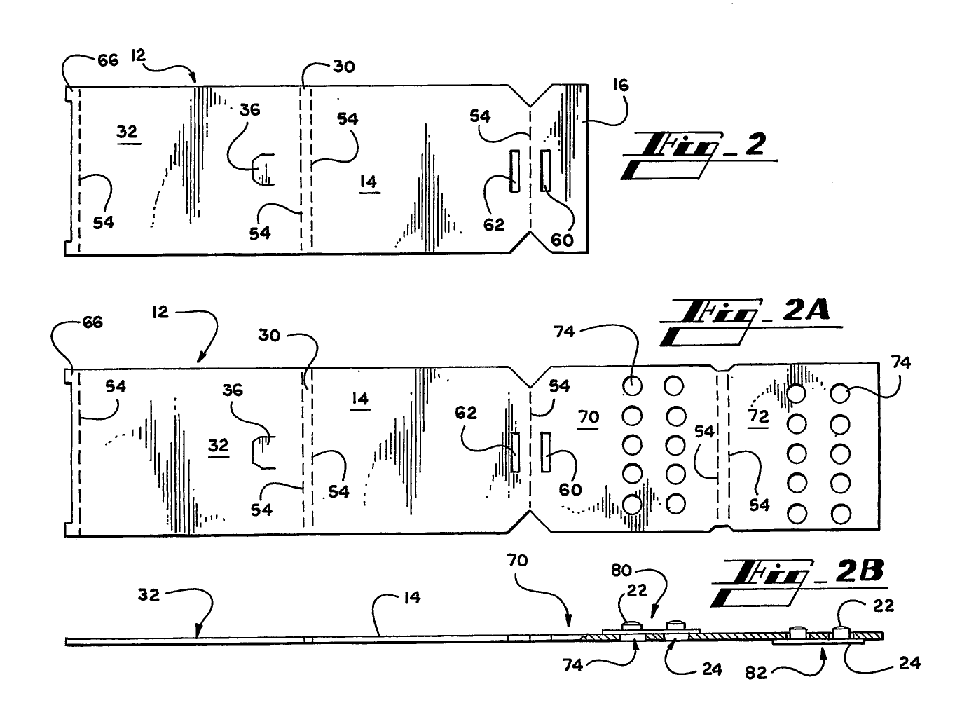

Referring now to the drawings, wherein like numerals represent like features throughout, there are illustrated embodiments of the present invention. Turning first to FIG. 1, one embodiment of a lockable container 10 according to the invention comprises a foldable portion 12, which in turn comprises a top panel 14 and a fold-over flap 16. In the illustrated embodiment a conventional blister pack 20, which comprises at least one blister or alevola 22 and a protective backing 24 (best shown in FIG. 2B), is attached to the fold-over flap 16. Here, one edge of the blister pack 20 is shown attached to an edge of the fold-over flap by either a chemical or mechanical means for attaching, or a combination thereof. By way of illustration and not limitation, means for attaching includes adhesives, glues, hot melts, bonding compounds, and similar chemical-based solutions for connecting materials. Means for attaching also includes interlocking tabs and slots, friction fit parts, latched parts, Velcro®, and similar mechanical-based solutions for connecting materials. Means for attaching also includes combinations of chemical and mechanical based solutions for attaching materials, such as single face tape, double face tape, welding, and the like as known by those skilled in the art. Means for attaching further includes a temporary or detachable connection as well as a permanent connection.

The top panel 14 may be foldably connected to an end panel 30 that forms the spine of the lockable container 10. A bottom panel 32 may be attached to a locking element 34, here shown as a molded plastic structure. Panel 32 includes, in the illustrated embodiment, a slot 36 cut to provide a movable region over a part of the molded locking element 34. In other embodiments, a cutout exposing elements of the molded locking element may replace the slot 36. The foldable portion 12 may be attached to the molded locking element 34 using any of the means for attaching described herein.

Locking element 34 comprises a locking flap 38, a locking tongue 40, and a frame base 42. Frame base 42 further comprises end panels 44 and side panels 46, which, here, are connected perpendicularly to form a rectangular frame defining the shape of the container 10. As will be understood by those skilled in the art, a rectangular frame is simply illustrative and not limiting as other frame shapes are possible, and even desirable. Locking element 34 further comprises a slot housing panel 48 having a slot 50 for engaging the locking flap 38 and a having a hollow area thereunder (not shown), where a curved dowel portion of the locking tongue 40 is stationed. In other embodiments, an interior panel (not shown) covers the locking elements and provides structure for text, graphics, or to attach a blister pack or card.

As shown in FIG. 2, the foldable portion 12 is formed as bottom panel 32, top panel 14, and fold-over flap 16 from a single blank of the chosen substrate material divided by fold lines 54. In practice, the extension 16 with attached blister pack 20 is folded inwardly toward and opened outwardly away from the top panel 14. Accordingly, the interior or exterior surfaces of the top panel 14 and extension 16 may be printed with text or graphics, or hold patient information stored on paper or a computer readable medium. Panels 14, 16 include optional slots 60, 62—positioned and sized to align when the panels 14, 16 are folded together; spine panel 30 and end panel 66 are also defined by fold lines 54. The slots 60, 62 are formed to allow dependent tab 64 (best shown in FIG. 1)—located on the inner side of locking flap 38, to pass through the panels 14, 16 when the container 10 is closed. The end panel 66 may be formed to permit a surface for attachment to a front end panel 44 and to protect the front edge of the container. The blank may be configured as needed to match the shape of the frame 42 and other design criteria, and may be provided in multiple parts.

As shown in the alternative embodiment illustrated in FIG. 2A, the foldable portion 12 is formed as bottom panel 32, a top panel 14, first blister card 70, and optional second blister card 72 from a single blank. Panel 14 and card 70 likewise include optional slots 60, 62—positioned and sized to align when the panel 14 and card 70 are folded together. Slots 60, 62 may be eliminated when a sufficiently wide locking flap 38 and sufficiently stiff foldable portion 12 is used. Further, blister cards 70, 72 include apertures 74 configured to align with a mounted blister pack, best shown on FIG. 2B.

FIG. 2B illustrates a back mounted blister pack 80 and a face-mounted blister pack 82. Here, blister pack 80 is a conventional push-through blister pack mounted on its protective cover 24 to one of the cards such that items (not shown) held within the blisters or alveoli 22 may pass through the protective cover 24 and aperture 74 without being hindered. Similarly, blister pack 82 is a conventional peel-drop blister pack mounted on its face to one of the cards such that items (not shown) held within the blisters or alveoli 22 positioned within apertures 74 may removed, after the protective cover 24 is at least partially removed, without being hindered. Here, blister packs 80, 82 are mounted to cards by either a chemical or mechanical means for mounting, or a combination thereof.

Those skilled in the art will readily observe that the present invention is not limited to the embodiments or arrangements illustrated in FIGS. 2, 2A and 2B. For example, fewer or more blister cards may be formed from the blank, blister packs may be face-mounted or back mounted, or both, to some or all of the blister cards, some blister packs may be mounted to blister cards while others are attached to fold-over cards within the same container, blister packs may be mounted to blister cards attached directly to a structure within the container, blister packs may be attached directly to a structure within the container, and blister packs may be simply mounted to a blister card to form what is often called a fold-over card that is then used of and by itself by the end-user to carry unit dose medicaments without the lockable container.

By way of illustration and not limitation, means for mounting includes adhesives, glues, hot melts, bonding compounds, and similar chemical-based solutions for connecting materials. Means for mounting also includes interlocking tabs and slots, friction fit parts, latched parts, Velcro®, and similar mechanical-based solutions for connecting materials. Means for mounting also includes combinations of chemical and mechanical based solutions for attaching materials, such as single face tape, double face tape, welding, and the like as known by those skilled in the art. Means for mounting further includes a temporary or detachable connection as well as a permanent connection.

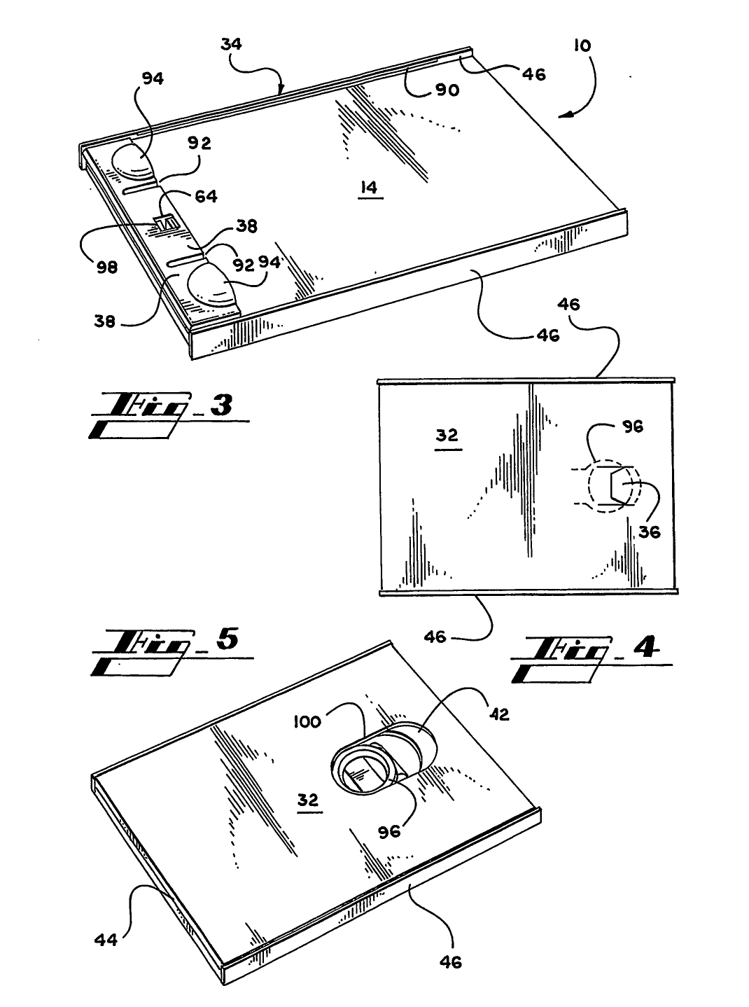

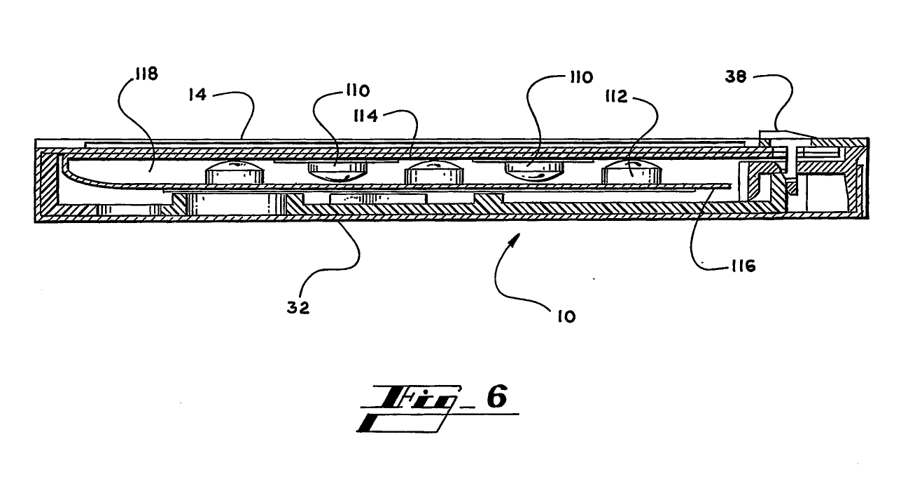

An isometric view of the closed lockable container 10 is shown in FIG. 3. When the container 10 is completely closed, top panel 14 is folded toward the interior of the frame and folds underneath locking flap 38. Panel 14 is held in position by ledges 90 located near the edges of side panels 46. When the panel 14 is pressed downward, its edges are pressed beneath and positively engaged by the ledges 90 and retained in position. Locking flap 38 may be trifurcated by a pair of slits 92, which divide the locking flap 38 into segments each having a limited range of movement in relation to the adjacent segment. Finger grips 94 are, in this embodiment, molded at either end of the flap 38. In other embodiments the grips may be curved, angled, or ribbed. Dividing the flap 38 into segments may enhance the safety feature, in that to open the package the user pulls at least one segment while engaging the pull ring 96 (shown in FIG. 5) to move the locking tongue 40 from the untensioned position. A slot 98 in the middle segment of locking flap 38, located directly above dependent tab 64, protrudes downward beneath the plane of the locking flap 38 to engage the locking tongue 40.

The underside or bottom of the container 10, as represented in FIGS. 4 and 5, shows a panel 32 on the exterior surface. The panel 32 abuts the bottom plane of the frame base and is held in place by a means for attaching, or by engagement with ledges 90 on side panels 46, or both. A depression is included in panel 32 to allow operation of the trigger mechanism beneath. In the embodiment shown, an angled notch is cut to form a node 36 above pull ring 96. The unattached node 36 may be depressed, thus enabling the user to grasp and manipulate the pull ring 96. Alternatively, the node 36 may be eliminated and a cutout 100 formed to partially or completely expose the pull ring 96. Concealment of the pull ring may add incrementally to the child resistance characteristics because access to the pull ring is less apparent.

FIG. 6 is a transverse section of a locked container 10 showing the internal position of blister packs 110, 112 containing unit doses mounted on blister cards 114, 116. Here, for purposes of illustration and not limitation, blister pack 110 is back mounted to blister card 114 while blister pack 112 is face mounted to blister card 116. In the folded and locked position, blister card 116 is folded to mate blister card 114 such that the blisters of the respective blister packs 110, 112 are nested, that is, are positioned to maximum efficiency of the interior space 118 of the closed container. Further, bottom panel 32 provides a protective cover on one side while top panel 14, trapped and secured by locking flap 38, provides a protective cover on the opposite side. Preferably, the container dimensions are such that the blisters may be stored without being compressed by the locking mechanism elements.

With regard to initial manufacturing and referring now to all the FIGS., the lockable container 10 is typically formed in a machine operation in which pre-cut, pre-folded blanks are connected to points of attachment on the bottom of the frame base 42, end panels 30, 44 and side panels 46. Ledges 90 along the length of side panels 46 may allow the foldable portion to be snap fit into the molded frame formed by these side and end panels. The blister pack(s) 20, 110, 112 may be attached to the fold-over flap 16, or mounted to the blister cards 70, 72, 114, 116, or the blister pack(s) may be attached to a structure located within the interior space 118 such that when the container 10 is locked the blisters 22 are secured and not readably accessible. With regard to subsequent use, emptied blister packs may be removed and new blister packs attached or mounted, as described herein, by the user or a third-party.

The present invention includes other embodiments, features and advantages that may not be herein described in detail, but would nonetheless be appreciated by those skilled in the art from the disclosures made. Accordingly, this disclosure is not to be read as limited only to the foregoing examples or only to the designated embodiments.

We claim:

1. An apparatus for connecting and securing a unit dose pack, comprising:
a first edge foldably attached to a frame having a locking element;
a distal second edge spaced apart from said first edge;
a fold line positioned between and substantially parallel to one of said edges;
a cover panel, defined by said first edge and said fold line, configured to engage said locking element; and,
a fold-over flap, defined by said second edge and said fold line, attached to a unit dose pack.

2. The apparatus of claim 1, wherein the surface area of said cover panel is greater than the surface area of said fold-over flap.

3. The apparatus of claim 2, wherein said fold-over flap comprises a means for attaching at least a portion of an edge of a blister pack.

4. The apparatus of claim 3, wherein said blister pack and fold-over flap are located within said frame and under said cover panel when said cover panel is lockably engaged.

5. The apparatus of claim 1, further comprising at least one aperture proximate to said fold line, such that when said panels are folded, said aperture is configured to lockably cooperate with a substantially perpendicular tab integral to said locking element.

6. A foldable blister pack mounting card formed of contiguous panels, comprising:
an exterior cover panel defined by a first end and a spaced apart first fold line;
a first interior fold-over panel defined by said first fold line and a spaced apart second fold line, having at least one aperture configured to surround at least one alveola located on a blister pack mounted to said first panel;
a second interior fold-over panel defined by said first fold line and a spaced apart second end, having at least one aperture configured to surround at least one alveola located on a blister pack mounted to said second panel, and,
wherein said cover panel is configured to overlay said fold-over panels and engage a locking element.

7. The card of claim 6, further comprising a first side and an opposite second side.

8. The card of claim 7, wherein each of said blister packs is mounted on the same of either of said sides.

9. The card of claim 7, wherein each of said blister packs is mounted on the opposite of either of said sides.

10. The card of claim 6, wherein the surface area of said cover panel is no less that the surface area of said first fold-over panel.

11. The card of claim 10, wherein the surface area of said first fold-over panel is no less than the surface area of said second fold-over panel.

12. A blister pack mounting card, comprising:
a blank panel having at least one aperture;
a blister pack including a protective covering and at least one alveola containing an item, said blister pack being mounted on said panel; and
a means for detachably connecting said blister card to a receiving appendage wherein said appendage is integral to a child-resistant container.

13. The card of claim 12, wherein said blister pack is a conventional push-through blister pack mounted such that said item may pass through said protective backing without being hindered by said panel.

14. The card of claim 12, wherein said blister pack is a conventional peel-drop blister pack mounted such that said item may be removed from said alveola without being hindered by said panel.

15. A method of resisting access to a blister pack, comprising the steps of:
providing a frame comprising a plurality of edges defining an interior, and at least one exterior lock flap;
attaching a first exterior cover adjacent to said frame that resists entry to said interior from a first side;
providing an appendage within said interior;
connecting a blister pack mounting card to said appendage;
mounting a blister pack, comprising at least one alveola and an adjacent protective backing, to said card;
attaching a removable second exterior cover adjacent to said frame;
positioning said blister pack within said interior and between said exterior covers;
capturing a portion of the outside surface of said second cover with said lock flap; and,
engaging said lock flap to secure said second cover.

16. The method of claim 15, wherein said step of providing a frame further comprises providing an integral locking element integral comprising a slidable locking tongue connected to a trigger mechanism at a first end and a lateral tab at a distal end.

17. The method of claim 15, wherein said step of mounting further comprises affixing at least a portion of the face of said blister pack to said card.

18. The method of claim 15, wherein said step of mounting further comprises affixing at least a portion of the back of said blister pack to said card such that the portion of said protective backing covering said alveola is not obstructed.

19. A mounted blister pack, comprising:
a blank panel having at least one aperture;
a blister pack including a protective covering and at least one blister containing an item;
a means for mounting said blister card to said blank panel; and,
wherein said aperture and blister are positioned such that said item may pass through said protective backing without being hindered by said panel.

20. The card of claim 19, wherein said blister pack is a conventional push-through blister pack.

21. The card of claim 20, wherein said blister pack is a conventional peel-drop blister pack.

22. A method of mounting a blister pack, comprising the steps of:
providing a blank panel having at least one aperture;
providing a blister pack including a protective covering and at least one blister containing an item;
aligning said blister with said aperture; and
adhering said blister card to said blank panel such that said item may pass through said protective backing without being hindered by said panel.

23. The card of claim 22, wherein the step of providing a blister pack further comprises providing a conventional push-through blister pack.

24. The card of claim 22, wherein the step of providing a blister pack further comprises providing a conventional peel-drop blister pack.
